(19) United States
(12) Patent Application Publication
(10) Pub. No.: US 2022/0391204 A1
(43) Pub. Date: Dec. 8, 2022

(54) Digital Signal Processor and Method

(71) Applicants: STMicroelectronics (Grenoble 2) SAS, Grenoble (FR); STMicroelectronics (Alps) SAS, Grenoble (FR)

(72) Inventors: Pierre Gobin, Seyssinet-Pariset (FR); Jeremy Ribeiro De Freitas, Coublevie (FR)

(21) Appl. No.: 17/829,784

(22) Filed: Jun. 1, 2022

(30) Foreign Application Priority Data
Jun. 4, 2021 (FR) 2105905

(51) Int. Cl. G06F 9/30; G06F 1/12

(52) U.S. Cl. CPC G06F 9/3001; G06F 1/12

(57) ABSTRACT

A digital signal processor according to an embodiment comprises a processing stage. The processing stage is configured to receive Cartesian coordinates of a vector in a floating point format and to output polar coordinates of the vector in a floating point format. The processing stage comprises a first electronic circuit configured to iteratively implement, timed by a clock signal, a CORDIC algorithm in a floating point format.

### CROSS-REFERENCE TO RELATED APPLICATIONS

This application claims priority to French Patent Application No. FR 2105905, filed on Jun. 4, 2021, which application is hereby incorporated herein by reference.

### TECHNICAL FIELD

The present invention relates generally to the field of circuits dedicated to signal processing and, in particular embodiments, to electronic circuits implementing the CORDIC algorithm.

### BACKGROUND

The CORDIC (“COordinate Rotation DIgital Computer”) algorithm allows performing rotations of a vector.

Such an algorithm is described by the article by Jack E Volder, entitled “the CORDIC Trigonometric Computing Technique”, IRE Transaction Electronic Computer EC-8: 330-334 (1959).

There are processing circuits dedicated to the implementation of the CORDIC algorithm.

Such dedicated processing circuits are for example configured to perform changes in reference frames by successive iterations, typically to transform Cartesian coordinates of a vector into polar coordinates. During each iteration of the CORDIC algorithm, the vector undergoes a single characteristic pseudo-rotation.

The dedicated processing circuits are typically configured to operate on data in a fixed point format, for example, the coordinates of the vector are processed as fixed point values.

There is a desire to implement a CORDIC algorithm within a digital signal processor.

There is also a desire to accelerate the processing of the CORDIC algorithm within such a digital signal processor.

### SUMMARY

According to one aspect there is proposed a digital signal processor, comprising a processing stage to receive input data, for example Cartesian coordinates of a vector, in a floating point format and to output polar coordinates of the vector, in a floating point format.

The processing stage includes at least one first electronic circuit configured to iteratively implement, timed by a clock signal, a CORDIC algorithm in the floating point format.

Thus, it is possible to process a CORDIC algorithm directly in the processing stage of the signal processor.

In addition, the processing stage allows processing coordinates expressed in a floating point format.

Implementing the CORDIC algorithm in the floating point format has in particular the advantage of avoiding having to convert the format of the data, for example coordinates, circulating between the processing stage and other processing units operating in floating point, which is in particular beneficial in terms of processing time.

According to one embodiment, the processing stage is configured to, during the implementation of the CORDIC algorithm, perform divisions by integer powers of 2, of data expressed in a floating point format, by subtracting for each division, the value of the power corresponding to the exponent of the corresponding data item.

Thus, the processing stage allows, by taking advantage of the floating point format, processing iterations of the CORDIC algorithm more quickly than in other dedicated circuits which use conventional dividers to perform these divisions by integer powers of 2.

More specifically, the processing stage allows carrying out the divisions of the algorithm by working only on the exponent bits of the floating point data item, which contributes to reducing the critical path to process each iteration of the algorithm.

A silicon space saving may be obtained.

According to a variant, the processing stage is configured to implement one iteration of the CORDIC algorithm per clock signal cycle.

According to one embodiment of this variant, the processing stage comprises a counter whose current value i corresponds to the rank of the current iteration of the algorithm, and the first electronic circuit comprises a first circuit input, a second circuit input, a third circuit input.

The first circuit comprises a first divider module having an input connected to the second circuit input and a first subtractor to subtract the current value of the counter from the exponent of the data item present at the second circuit input, the output of the first divider module delivering said data item present at the second circuit input divided by 2ⁱ.

The first circuit also comprises a second divider module having an input connected to the first circuit input and a second subtractor to subtract the current value of the counter from the exponent of the data item present at the first circuit input, the output of the second divider module delivering said data item present at the first circuit input divided by 2ⁱ.

The first electronic circuit comprises a first adder/subtractor having a first input connected to the first circuit input and a second input connected to the output of the first subtractor.

The first electronic circuit also comprises a second adder/subtractor having a first input connected to the second circuit input and a second input connected to the output of the second subtractor.

The first electronic circuit further comprises a third adder/subtractor having a first input connected to the third circuit input and a second input for receiving an angular pitch value associated with the current value of the counter.

The configuration of each adder/subtractor as an adder or as a subtractor is defined by the sign of the data item present at the second circuit input.

Thus, given that the first circuit allows processing an iteration of the CORDIC algorithm, then the first subtractor module and the second subtractor module, which perform the divisions by integer powers of 2, allow reducing the critical paths of the first circuit, and therefore accelerating the processing of each iteration.

Indeed, the first module and the second module allow carrying out divisions by 2ⁱ by a simple subtraction of the exponent of the data item of rank i of the current iteration.

According to one embodiment, the processing stage further comprises a controller, for example made by a state machine and/or by logic circuits.

The controller is configured to, at the beginning of the first iteration of the algorithm, deliver an initial abscissa data item representative of the abscissa of the vector on the first circuit input, an initial ordinate data item representative of the ordinate of the vector on the second circuit input, and an initial angular value on the third circuit input.

The controller is also configured to increment the counter at each subsequent new iteration of the algorithm.

The controller is further configured to deliver on the second input of the third adder/subtractor of this first circuit, the angular pitch value associated with the current value of the counter.

Thus, the controller allows initializing the implementation of the CORDIC algorithm and managing, in particular for the first circuit, the incrementation of the rank of the current iteration and the provision of the corresponding angular pitch value.

According to one embodiment, the controller is configured to deliver at the end of a current iteration, the output value of the first adder/subtractor on the first circuit input, the output value of the second adder/subtractor on the second circuit input, the output value of the third adder/subtractor on the third circuit input, so as to process one iteration per clock signal cycle.

Thus, the controller allows looping back the CORDIC algorithm such that the output values are fed back into the inputs of the first circuit.

According to another particularly advantageous variant, the processing stage is configured to implement two iterations of the CORDIC algorithm per clock signal cycle while dispensing with the use of conventional dividers to perform divisions by integer powers of 2, which allows a notable reduction in the critical path between the input and the output of the processing stage.

Thus, the processing stage allows the CORDIC algorithm to be processed more quickly.

According to one embodiment of this other variant, the processing stage comprises a first electronic circuit and a second electronic circuit, having a structure similar to that of the first electronic circuit, connected downstream of the first electronic circuit.

The first electronic circuit is intended to implement during a clock cycle, a current iteration of the algorithm, and the second electronic circuit is intended to implement during this clock cycle, the next iteration of the algorithm.

Thus, the combination of the first circuit and the second circuit allows making two iterations of the CORDIC algorithm per clock signal cycle.

In addition, the first circuit has a structure similar to the second circuit, which allows simplifying the design of the processing stage.

The first electronic circuit is advantageously configured to implement the iterations of even ranks and the second electronic circuit is advantageously configured to implement the iterations of odd ranks.

According to one embodiment, said processing stage comprises a counter whose current value i corresponds to half of the rank of a current iteration of even rank of the algorithm, and the first electronic circuit comprises: a first circuit input, a second circuit input, a third circuit input; a first divider module having an input connected to the second circuit input and a first subtractor to subtract the value 2ⁱ from the exponent of the data item present at the second circuit input, the output of the first divider module delivering said data item present at the second circuit input divided by 2²ⁱ; a second divider module having an input connected to the first circuit input and a second subtractor to subtract the value 2ⁱ from the exponent of the data item present at the first circuit input, the output of the second divider module delivering said data item present at the first circuit input divided by 2²ⁱ; a first adder/subtractor having a first input connected to the first circuit input, a second input connected to the output of the first subtractor; a second adder/subtractor having a first input connected to the second circuit input, a second input connected to the output of the second subtractor; a third adder/subtractor having a first input connected to the third circuit input and a second input to receive an angular pitch value associated with the value 2ⁱ; and the configuration of each adder/subtractor as an adder or as a subtractor being defined by the sign of the data item present at the second circuit input.

Moreover, according to one embodiment: the first input of the first adder/subtractor of the second circuit is connected to the output of the first adder/subtractor of the first circuit; the first input of the second adder/subtractor of the second circuit is connected to the output of the second adder/subtractor of the first circuit; the first input of the third adder/subtractor of the second circuit is connected to the output of the third adder/subtractor of the first circuit; the input of the first divider module of the second circuit is connected to the output of the second adder/subtractor of the first circuit, and the first subtractor of this first divider module of the second circuit is configured to subtract the value 2i+1 from the exponent of the data item present at the output of the second adder/subtractor of the first circuit of circuit, the output of the first divider module of this second circuit delivering said data item present at the output of the second adder/subtractor of the first circuit divided by 2²ⁱ+1; the input of the second divider module of the second circuit is connected to the output of the first adder/subtractor of the first circuit, and the second subtractor of this second divider module of the second circuit is configured to subtract the value 2i+1 from the exponent of the data item present at the output of the first adder/subtractor of the first circuit of circuit, the output of the second divider module of this second circuit delivering said data item present at the output of the first adder/subtractor of the first circuit of circuit divided by 2²ⁱ+1; the second input of the third adder/subtractor being intended to receive an angular pitch value associated with the value 2i+1; and the adder or subtractor configuration of each adder/subtractor of this second circuit being defined by the sign of the data item present at the output of the second adder/subtractor of the first circuit.

Thus, the processing stage allows processing each of the two iterations of the CORDIC algorithm per clock cycle by taking advantage of the floating point format to accelerate the processing of the algorithm.

According to one embodiment, the processing stage further comprises a controller configured to: at the beginning of the first iteration of the algorithm, which is for example the iteration of rank 0, deliver an initial abscissa data item representative of the abscissa of the vector on the first circuit input, an initial ordinate data item representative of the ordinate of the vector on the second circuit input, and an initial angular value on the third circuit input; increment the counter at each subsequent new iteration of the algorithm; deliver on the second input of the third adder/subtractor of this first circuit, the angular pitch value associated with the value 2i; and deliver on the second input of the third adder/subtractor of the second circuit, the angular pitch value associated with the value 2i+1.

The controller is also configured to deliver, at the end of the iteration of odd rank following an iteration of even rank, the output value of the first adder/subtractor of the second circuit on the first circuit input, the output value of the second adder/subtractor of the second circuit on the second circuit input, the output value of the third adder/subtractor of the second circuit on the third circuit input, so as to process, during the same clock signal cycle, said iteration of even rank and said iteration of odd rank.

Thus, the controller allows providing the second circuit with the angular pitch corresponding to the value 2i+1.

In addition, the controller allows looping back the CORDIC algorithm such that the output values of the second circuit are fed back into the inputs of the first circuit at the next iteration.

According to one embodiment, the processing stage further comprises an initialization electronic circuit configured to deliver the initial abscissa data item, the initial ordinate data item and the initial angular value from the abscissa and the ordinate of the vector.

According to one embodiment, the initialization circuit is configured to deliver, as initial abscissa data item, initial ordinate data item and initial angular value, respectively: the abscissa of the vector, the ordinate of the vector, and a zero angular value, if the abscissa of the vector is positive; the opposite of the ordinate of the vector, the abscissa of the vector and an angular value equal to

$$- \frac{π}{2} ,$$

if the abscissa and the ordinate of the vector are negative; and the ordinate of the vector, the opposite of the abscissa of the vector and an angular value equal to

$$+ \frac{π}{2} ,$$

if the abscissa of the vector is negative and if the ordinate of the vector is positive.

Thus, the initialization electronic circuit allows providing the first circuit with an initial triplet (initial abscissa, initial ordinate, initial angular value) for which the CORDIC algorithm is able to converge.

In particular, the initialization circuit allows the processor to be able to process any vector of the plane by transforming this vector into an initial vector whose angular value is comprised between

$$- \frac{π}{2} and + \frac{π}{2} .$$

According to another aspect, a servo system is proposed, comprising a servo loop integrating the digital signal processor as defined above, connected to an electric motor.

Thus, the servo system benefits from the computational speed of the signal processor, which allows improving the accuracy of the servo loop.

### BRIEF DESCRIPTION OF THE DRAWINGS

Other advantages and features will appear on examining the detailed description of embodiments and implementations, which are in no way limiting, and of the appended drawings in which:

FIG. 1 schematically illustrates an example of a digital signal processor, in accordance with some embodiments;

FIG. 2 schematically illustrates a processing stage of a digital signal processor, in accordance with some embodiments;

FIG. 3 illustrates a divider module of a processing stage, in accordance with some embodiments;

FIG. 4 schematically illustrates a processing stage of a digital signal processor, in accordance with some other embodiments;

FIG. 5 schematically illustrates an initialization circuit of a digital signal processor, in accordance with some other embodiments; and

FIG. 6 schematically illustrates a system integrating a digital signal processor, in accordance with some embodiments.

### DETAILED DESCRIPTION OF ILLUSTRATIVE EMBODIMENTS

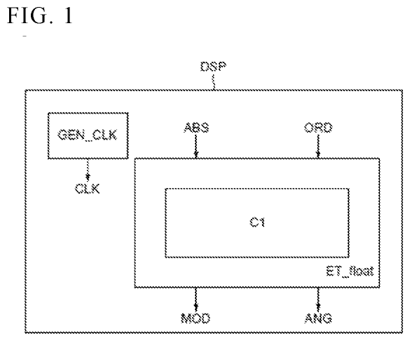

FIG. 1 schematically illustrates an example of a digital signal processor DSP adapted to implement iterations of a CORDIC algorithm on floating point data.

In particular, the digital signal processor DSP allows performing changes in reference frames by transforming Cartesian coordinates into polar coordinates by the CORDIC algorithm.

To this end, the digital signal processor DSP comprises a processing stage ET_float dedicated to the implementation of the CORDIC algorithm and configured to process floating point data, and a clock generator GEN_CLK for generating a clock signal CLK intended to clock the processing stage ET_float.

By convention, the Cartesian coordinates comprise an abscissa ABS and an ordinate ORD, and the polar coordinates comprise a modulus MOD and an angle value ANG measured relative to the origin.

The processing stage ET_float is configured to receive the Cartesian coordinates ABS, ORD of a vector in a floating point format and to process successive iterations of the algorithm so as to deliver the polar coordinates MOD, ANG of the vector in a floating point format.

For this, the processing stage ET_float stage includes at least one first electronic circuit C1 capable of processing data in a floating point format.

The circuit C1 is configured to implement, one by one, timed by a clock signal CLK, the iterations of the CORDIC algorithm.

Generally, each iteration of the algorithm comprises divisions by integer powers of 2.

Advantageously, as will be seen in more detail below, the processing stage ET_float, and in particular the first circuit C1, is configured to perform divisions by integer powers of 2 by not using conventional dividers, but by simply subtracting the exponent of the floating point data item to be divided by the value of the corresponding power of 2.

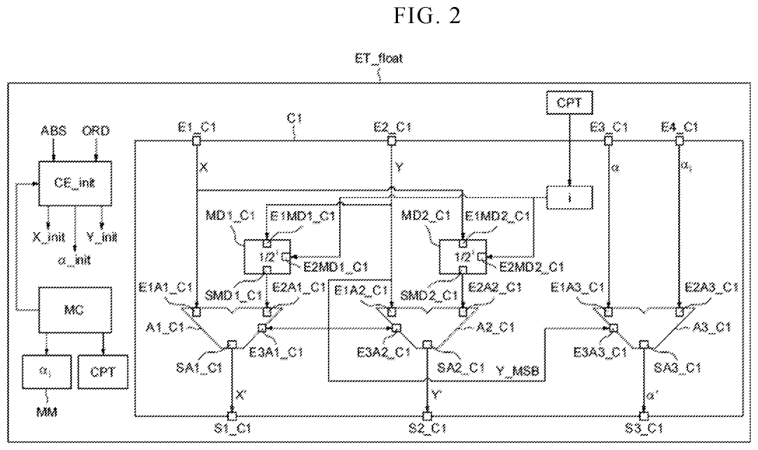

FIG. 2 schematically illustrates an example of the processing stage ET_float comprising herein the first circuit C1.

The processing stage ET_float further comprises a controller MC to monitor and manage each iteration, a counter CPT to indicate the ranks of the successive iterations of the algorithm and an initialization electronic circuit CE_init to provide the first circuit with initial data to be processed during the first iteration.

The counter CPT is intended for example to be incremented timed by the clock signal CLK, and to deliver a current value i corresponding to the rank of the iteration during processing in the first circuit C1.

The processing stage ET_float comprises a memory MM adapted to store a set of angular pitch values al characteristic of the CORDIC algorithm. The angular pitch values al are calculated in advance and stored in the memory MM. Alternatively, it is possible for the memory MM to be located outside the processing stage ET_float.

The first circuit C1 is configured to implement a single iteration of the CORDIC algorithm per clock signal cycle CLK.

For this purpose, the first electronic circuit C1 comprises three blocks, a first block to process a data item X and deliver a data item X′, a second block to process the data item Y and deliver the data item Y′ and a third block to process the data item α and deliver the data item α′.

The first electronic circuit C1 comprises, in the first block, a first divider module MD1_C1 and a first adder/subtractor A1_C1, in the second block, a second divider module MD2_C1 and a second adder/subtractor A2_C1, and in the third block, a third adder/subtractor A3_C1.

The first circuit C1 is configured so that after a predetermined number of iterations, the data item X′ is substantially equal to the modulus of the vector in a polar reference frame and the data item α is an approximation of the angle of the vector with the origin in the polar reference frame.

This number of iterations can be at most equal to 24 to obtain a maximum accuracy, but can be reduced to ten to obtain a lower accuracy.

Concerning the inputs of the first circuit C1, they include a first circuit input E1_C1 intended to receive the data item X, a second circuit input E2_C1 intended to receive the data item Y, a third circuit input E3_C1 intended to receive the data item α, and a fourth circuit input E4_C1 intended to receive the angular pitch αᵢ.

Concerning the outputs of the first circuit C1, they include a first circuit output S1_C1 intended to deliver the data item X′, a second circuit output S2_C1 intended to deliver the data item Y′, and a third circuit output S3_C1 intended to deliver the data item α′.

Concerning the divider modules of the first circuit C1, the first divider module MD1_C1 is configured to subtract the current value i of the counter from the exponent of the data item Y, so as to deliver the value Y/2ⁱ.

The first divider module MD1_C1 has an input E1MD1_C1 connected to the second circuit input E2_C1 and intended to receive the data item Y, an input E2MD1_C1 connected to the counter CPT and intended to receive the value i of the current iteration, and an output SMD1_C1 connected to a second input E2A1_C1 of the first adder/subtractor A1_C1 and intended to deliver the data item Y divided by 2ⁱ.

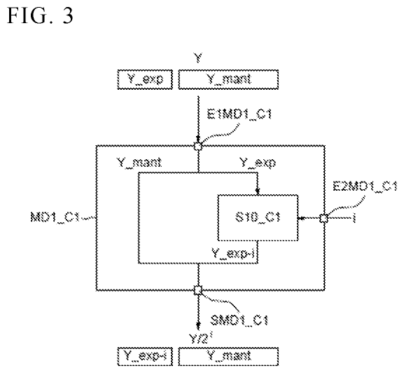

FIG. 3 illustrates in more detail the first divider module MD1_C1 which comprises a first subtractor S10_C1.

The data item Y conventionally comprises in floating point format, bits forming an exponent Y_exp and bits forming a mantissa Y_mant.

The first divider module comprises a data bus to circulate the bits of the data item Y.

The bus is separated into two branches, a first branch configured to circulate the bits of the mantissa Y_mant of the data item Y between the first input E1MD1_C1 and the output SMD1_C1 of the first divider module MD1_C1, and a second branch configured to circulate the bits from the exponent Y_exp of the data item Y to the first subtractor S10-C1.

In this regard, the first subtractor S10_C1 comprises a first input connected to the first input E1MD1_C1 of the first divider module MD1_C1 to receive the exponent Y_exp of the data item Y.

The first subtractor S10_C1 also comprises a second input connected to the second input E2MD1 of the first divider module MD1_C1 intended to receive the value of rank i of the current iteration in the first circuit C1.

The first subtractor S10_C1 is configured to subtract from the exponent of data item Y, the value of the rank i of the current iteration.

This subtraction in the first subtractor S10_C1, is as illustrated in FIG. 3, implemented by isolating the exponent and through carrying out an unsigned subtraction of the quantity i of the bits constituting the exponent.

The first subtractor S1_C1 further comprises an output connected to the output SMD1_C1 of the first divider module MD1_C1 to deliver the result Y_exp-i of the subtraction.

The output SMD1_C1 of the first divider module MD1_C1 therefore delivers the data item Y/2ⁱ having as exponent Y_exp-i and as mantissa Y_mant.

The second divider module MD2_C1 is configured to subtract the current value i of the counter from the exponent of the data item X, so as to deliver the data item X/2ⁱ.

Referring back to FIG. 1, second divider module MD2_C1 has an input E1MD2_C1 connected to the first circuit input E1_C1 and intended to receive the data item X, an input E2MD2_C1 connected to the counter CPT and intended to receive the value i of the current iteration, and an output SMD2_C1 connected to a second input E2A2_C1 of the second adder/subtractor A2_C1 and intended to deliver the data item X divided by 2′.

The structure and operation of the second divider module MD2_C1, which comprises in particular a second subtractor, are similar to those of the first divider module MD1_C1 described in relation to FIG. 3.

The first adder/subtractor A1_C1 has a first input E1A1_C1 connected to the first circuit input E1_C1, a second input E2A1_C1 connected to the output of the first divider module MD1_C1, and a third input E3A1_C1 intended to receive the most significant bit MSB_Y of the data item Y.

The first adder/subtractor A1_C1 also has an output SA1_C1 connected to the first circuit output S1_C1 and intended to deliver the data item X′, which is the output value of the second block for the current iteration.

The second adder/subtractor A2_C1 has a first input E1A2_C1 connected to the second circuit input E2_C1, a second input E2A2_C1 connected to the output of the second divider module MD2_C1, which also happens to be the output of the second subtractor, and a third input E3A2_C1 intended to receive the most significant bit MSB_Y of the data item Y.

The second adder/subtractor A2_C1 also has an output SA2_C1 connected to the second circuit output S2_C1 and intended to deliver the data item Y′, which is the output value of the second block for the current iteration.

The third adder/subtractor A3_C1 has a first input E1A3_C1 connected to the third circuit input E3_C1, a second input E2A3_C1 connected to the fourth circuit input E4_C1 intended to receive the angular pitch value αᵢ associated with the current value of the counter CPT, and a third input E3A3_C1 intended to receive the most significant bit MSB_Y of the data item Y.

The third adder/subtractor A3_C1 also has an output SA3_C1 connected to the third circuit output S3_C1 and intended to deliver the data item α′, which is the output value of the third block for the current iteration.

The configuration of each adder/subtractor as an adder or as a subtractor depends on the most significant bit MSB_Y representing the sign of the data item Y.

For example, if the most significant bit MSB_Y of the data item Y is equal to 1, the corresponding adder/subtractor performs a subtraction and if the most significant bit MSB_Y of the data item Y is equal to 0 then this adder/subtractor performs an addition.

Thus the first adder/subtractor C1 is configured to add the data item Y to the data item X divided by 2ⁱ if the sign of the data Y is positive, or to subtract the data item Y from the data item X divided by 2ⁱ if the sign of the data Y is negative.

The second adder/subtractor A2_C1 is configured to subtract the data item X divided by 2ⁱ from the data item Y if the sign of the data item Y is positive, or to add the data item Y to the data item X divided by 2ⁱ if the sign of the data Y is negative.

The third adder/subtractor A3_C1 is configured to add the angular pitch value αᵢ of the current iteration to the data item α if the sign of the data item Y is positive, or to subtract the angular pitch value αᵢ of the current iteration from the data item α if the sign of the data item Y is negative.

The controller MC is configured to control an initialization circuit CE_init so as to deliver to the first circuit C1 an initial data triplet at the beginning of the first iteration of the algorithm.

The initial data triplet comprises an initial abscissa X_init, representative of the abscissa of the vector, delivered on the first circuit input E1_C1, an initial ordinate data item Y_init representative of the ordinate of the vector, delivered on the second circuit input E2_C1, and an initial angular value α_init delivered on the third circuit input E3_C1.

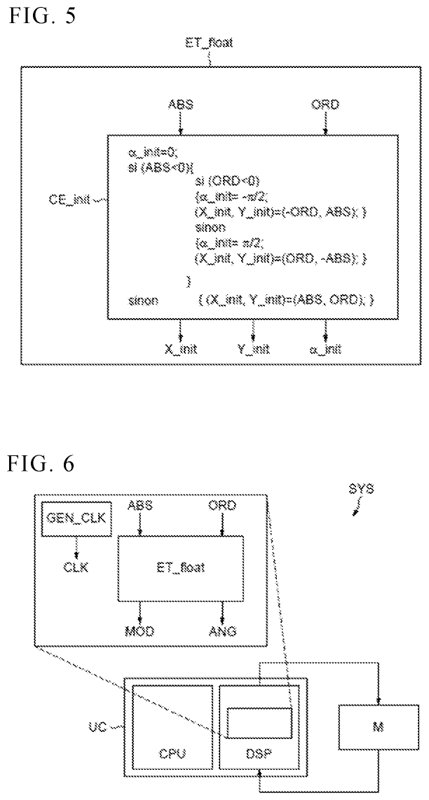

In the description relating to FIG. 5, the initialization circuit CE_init and the obtaining of the initial data triplet X_init, Y_init, α_init will be discussed in more detail.

The controller MC is also configured to control the incrementation of the counter CPT at each new iteration of the CORDIC algorithm.

The controller MC is further configured to control the reading in the memory MM of the angular pitch value αᵢ associated with the current value of the counter CPT and deliver this value to the second input E2A3_C1 of the third adder/subtractor A3_C1.

The controller MC is configured to control a loopback of the values obtained at the output of each block to the respective inputs thereof at the end of each cycle of the clock signal (except the last), that is to say in an embodiment, after each iteration (except the last) of the CORDIC algorithm.

In particular, the controller MC is configured to loop back, at the end of a current iteration, the output value X′ of the first adder/subtractor A1_C1 on the first circuit input E1_C1, the output value Y′ of the second adder/subtractor A2_C1 on the second circuit input E2_C1, and the output value α′ of the third adder/subtractor A3_C3 on the third circuit input E3_C1.

At the end of the last iteration: the data item X′ is representative of the module of the vector (provided that the obtained magnitude is the modulus of the initial vector multiplied by a constant K that depends on the number of iterations), the data a′ is representative of the angle thereof, and the data Y′ is zero or almost zero.

More specifically K is equal to 1.646760255 for 24 iterations, and more generally K is equal to the product (1+2⁻⁰)^{1/2}·(1+2⁻²)^{1/2} . . . (1+2⁻⁽ⁿ⁻²⁾)^{1/2}.

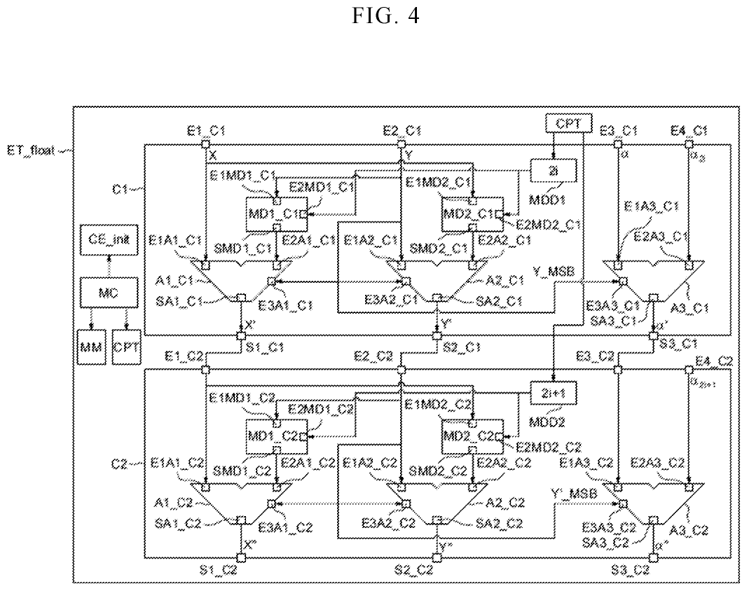

FIG. 4 schematically illustrates an embodiment in which the processing stage ET_float is configured to process two iterations of the CORDIC algorithm per clock signal cycle CLK.

This is possible by the presence of the divider modules which allow performing the divisions by integer powers of 2 without using dividers, which reduces the length of the critical path of the processing stage.

This particularly advantageous embodiment allows determining the modulus and the angle of the vector more quickly.

For example, the frequency of the clock signal CLK may be in the range of 250 MHz in a 40 nm CMOS technology.

Thus, the processing stage ET_float comprises the first circuit C1 as described in relation to the preceding figures and a second circuit C2, of a structure similar to the first electronic circuit C1, connected downstream of the first circuit C1. As shown in FIG. 4, in this context, circuits have similar structures when they include the same elements connected in the same manner.

During a cycle of the clock signal CLK, the first electronic circuit C1 is intended to implement a current iteration of even rank of the CORDIC algorithm and the second electronic circuit C2 is intended to implement the next iteration of odd rank, always during the same clock signal cycle CLK.

More specifically, the counter CPT is again incremented, timed by the clock signal CLK, by the controller MC, but its current value i corresponds to half of the rank 2i of a current iteration of even rank of the algorithm.

Thus the counter CPT ultimately only counts half of the requested number of iterations.

The first iteration is the even iteration of rank 0.

The first circuit C1 implements the current iteration of rank 2i in the manner described in relation to FIGS. 2 and 3, with the difference that the first circuit comprises herein a module MDD1 receiving the value i from the counter CPT and delivering the value 2i at the inputs E2MD1_C1 and E2MD2_C1.

Thus the modules MD1_C1 and MD2_C1 perform the divisions by 2²ⁱ of the data respectively present at the input of these two modules.

A particularly simple manner to implement the multiplication by 2 performed in the module MDD1, can consist in delivering the number i using an initial word of I bits on a bus of I bits, for example 5 bits, and to connect between the output of the module MDD1 and the inputs E2MD1_C1 and E2MD2_C1, a bus of I+1 bits, for example 6 bits, so as to present to these inputs a word of I+1 bits whose least significant bit is forced to 0 and whose I other bits correspond to the I bits of the initial word representing the number i.

Moreover, the controller MC is configured to control the reading in the memory MM of the angular pitch value α₂ᵢ associated with the value 2i and deliver this value on the second input E2A3_C1 of the third adder/subtractor A3_C1.

The second circuit C2 implements the next iteration of rank 2i+1 in the same manner as the first circuit implements the iteration of rank 2i, with the difference that divisions by 2²ⁱ⁺¹ are this time performed by the second circuit C2 instead of the divisions by 2²ⁱ performed by the first circuit C1.

The majority of the elements of the second circuit C2 are similar to the elements of the first circuit C1, in particular from the point of view of their structure and their operation.

Thus, for the sake of brevity, the references associated with the elements of the second circuit C2 are similar to the references associated with the elements of the first circuit C1.

The distinction between the references of the first and second circuits lies in the mention “_C1” to refer to the first circuit and in the mention “_C2” to refer to the second circuit.

Structurally, as indicated above, the second circuit C2 is connected downstream of the first electronic circuit C1.

In particular, the first circuit input E1_C2 of the second circuit C2 is connected to the first circuit output S1_C1 of the first circuit C1 delivering the data item X′.

The second circuit input E2_C2 of the second circuit C2 is connected to the second output S2_C1 of the first circuit C1 delivering the data item Y′.

The third circuit input of circuit E3_C2 of the second circuit C2 is connected to the third circuit output S3_C1 of the first circuit C1 delivering the data α′.

Unlike the first circuit C1, the second circuit comprises herein a module MDD2 receiving the value i from the counter CPT and delivering the value 2i+1 to the inputs E2MD1_C2 and E2MD2_C2.

Thus the modules MD1_C2 and MD2_C2 perform the divisions by 2²ⁱ⁺¹ of the data respectively present at the input of these two modules.

A particularly simple manner for implementing the multiplication by 2 increased by 1, performed in the module MDD2, can consist in delivering the number i using the initial word of I bits on the bus of I bits, for example 5 bits, and connecting between the output of the module MDD2 and the inputs E2MD1_C2 and E2MD2_C2, a bus of I+1 bits, for example 6 bits, so as to present to these inputs a word of I+1 bits whose least significant bit is forced to 1 and whose I other bits correspond to the I bits of the initial word representing the number i.

Thus, in the first block of the second circuit C2, the first divider module MD1_C2 is configured to subtract the value 2i+1, from the exponent of the data item Y′.

Consequently, the output of the first divider module MD1_C2 of this second circuit delivers the data item Y′ divided by 2²ⁱ⁺¹.

Then, the output of the first adder/subtractor A1_C2 of the second circuit C2 delivers the data X″ which is the output value of the first block of the second circuit C2 at the iteration of rank 2i+1.

In parallel, concerning the second block of the second circuit C2, the second divider module MD2_C2 is configured to subtract the value 2i+1, from the exponent of the data item X′.

Consequently, the output of the second divider module MD2_C2 of this second circuit delivers the data item X′ divided by 2²ⁱ⁺¹.

Then, the output of the second adder/subtractor A2_C2 of the second circuit C2 delivers the data item Y″ which is the output value of the second block of the second circuit C2 at the iteration of rank 2i+1.

Concerning the third block of the second circuit C2, the second input of the third adder/subtractor A3_C2 is intended to receive an angular pitch value α₂ᵢ₊₁ associated with the value 2i+1.

Consequently, the output of the third adder A3_C2 of the second circuit C2 delivers the data α″ which is the output value of the third block of the second circuit C2 at the iteration of rank 2i+1.

In this embodiment, the controller MC is configured to control the reading of the angular pitch value α₂ᵢ₊₁ associated with the iteration of rank 2i+1, with a view to its delivery on the fourth circuit input of the second circuit C2.

Moreover, the controller MC is then configured to loop back outputs of the blocks of the second circuit C2 on respective inputs of the blocks of the first circuit C1.

In particular, the controller MC is configured to deliver at the end of the iteration of rank 2i+1, the output value X″ of the second block of the second circuit C2 on the first circuit input E1_C1, the output value Y″ of the second block of the second circuit C2 on the second circuit input E2_C1, and the output value α″ of the third block of the second circuit on the third circuit input E3_C1.

At the end of the last iteration, the data X″ is representative of the module of the vector (within the constant K), the data α″ is representative of the angle thereof and the data Y″ is zero or almost zero.

FIG. 5 schematically illustrates the initialization electronic circuit CE_init, mentioned above in relation to FIGS. 2 and 4.

The initialization circuit is configured to generate, from the abscissa ABS and the ordinate ORD of the vector, an initial data triplet comprising, on the one hand, an initial vector formed of the initial abscissa data item X_init and of the initial ordinate data item Y_init and on the other hand, the initial angular value α_init.

The generation of the data triplet by the initialization electronic circuit CE_init is controlled by the controller MC (see FIGS. 2 and 4).

Concerning the initial vector, the initialization circuit CE_init is configured to perform a rotation if the Cartesian vector whereon it is intended to change the reference frame is located in the half-plane of the negative abscissas.

Typically, for Cartesian vectors located in this half-plane, the CORDIC algorithm does not converge and it is therefore advantageous to generate an initial vector located in the plane of the positive abscissas, obtained by a rotation of

$$- \frac{π}{2}$$

or of

$$\frac{π}{2}$$

of the Cartesian vector depending on whether the sign of the ordinate ORD is negative or positive.

The initial angular value α_init then takes respectively either the value

$$- \frac{π}{2}$$

or the value

$$\frac{π}{2} ,$$

always according to the sign of the ordinate ORD, which allows taking into account this initial rotation of the Cartesian vector.

If, on the contrary, the Cartesian vector is located in the half-plane of the positive abscissas, then the initial vector is equal to the Cartesian vector and the initial angular value α_init is set to zero.

FIG. 6 schematically illustrates a servo system SYS integrating a monitoring unit UC, for example a microcontroller such as that marketed by the company STMicroelectronics under the reference STM32, connected to an electric motor M.

The monitoring unit UC comprises a processing unit CPU and a digital signal processor DSP described above to implement a servo-control of the electric motor M.

For the servo-control of the motor M, it may for example be advantageous to perform changes in reference frame to transform vector Cartesian coordinates into polar coordinates.

In particular, these changes in reference frame are all the more advantageous if they are implemented quickly, for example if they concern the rotation of the motor, and even more so if the speed of rotation of the motor is significant.

Thus, it is advantageous for the servo loop to implement the digital signal processor DSP as described above, such as in the embodiments of FIG. 2 or 4, in order to quickly implement iterations of the CORDIC algorithm.

What is claimed is:

1. A digital signal processor comprising:
a processing stage configured to receive Cartesian coordinates of a vector in a floating point format and to output polar coordinates of the vector in a floating point format, the processing stage comprising a first electronic circuit configured to iteratively implement, timed by a clock signal, a CORDIC algorithm in a floating point format.

2. The digital signal processor according to claim 1, wherein the processing stage is configured to, during the implementation of the CORDIC algorithm, perform divisions by integer powers of 2, of data expressed in a floating point format, by subtracting for each division, the integer power corresponding to an exponent of the data.

3. The digital signal processor according to claim 1, wherein the processing stage is configured to implement one iteration of the CORDIC algorithm per clock signal cycle.

4. The digital signal processor according to claim 1, wherein the processing stage further comprises a counter configured to deliver a current value i, wherein the current value i corresponds to a rank of a current iteration of the CORDIC algorithm, and wherein the first electronic circuit comprises:
a first circuit input, a second circuit input, and a third circuit input;
a first divider module comprising an input connected to the second circuit input and a first subtractor configured to subtract the current value i of the counter from an exponent of a data item present at the second circuit input, an output of the first subtractor delivering the data item present at the second circuit input divided by 2i;
a second divider module comprising an input connected to the first circuit input and a second subtractor configured to subtract the current value i of the counter from an exponent of a data item present at the first circuit input, an output of the second subtractor delivering the data item present at the first circuit input divided by 2i;
a first adder/subtractor comprising a first input connected to the first circuit input and a second input connected to the output of the first subtractor;
a second adder/subtractor comprising a first input connected to the second circuit input and a second input connected to the output of the second subtractor; and
a third adder/subtractor comprising a first input connected to the third circuit input and a second input for receiving an angular pitch value associated with the current value i of the counter,
wherein a configuration of each of the first, second, and third adder/subtractor as an adder or as a subtractor is defined by a sign of the data item present at the second circuit input.

5. The digital signal processor according to claim 4, wherein the processing stage further comprises a controller configured to:
at the beginning of a first iteration of the CORDIC algorithm, deliver an initial abscissa data item representative of the abscissa of the vector on the first circuit input, an initial ordinate data item representative of the ordinate of the vector on the second circuit input, and an initial angular value on the third circuit input;
increment the counter at each subsequent new iteration of the CORDIC algorithm; and
deliver on the second input of the third adder/subtractor, the angular pitch value associated with the current value i of the counter.

6. The digital signal processor according to claim 5, wherein the controller is further configured to deliver, at the end of a current iteration of the CORDIC algorithm, an output value of the first adder/subtractor on the first circuit input, an output value of the second adder/subtractor on the second circuit input, and an output value of the third adder/subtractor on the third circuit input.

7. The digital signal processor according to claim 1, wherein the processing stage is configured to implement two iterations of the CORDIC algorithm per clock signal cycle.

8. The digital signal processor according to claim 7, wherein the processing stage further comprises a second electronic circuit having a structure similar to that of the first electronic circuit, the second electronic circuit connected downstream of the first electronic circuit, the first electronic circuit being configured to implement during a clock cycle, a current iteration of the CORDIC algorithm, the second electronic circuit being configured to implement during the clock cycle, a next iteration of the CORDIC algorithm.

9. The digital signal processor according to claim 8, wherein the first electronic circuit is configured to implement iterations of even ranks of the CORDIC algorithm, and wherein the second electronic circuit is configured to implement iterations of odd ranks of the CORDIC algorithm.

10. The digital signal processor according to claim 8, wherein the processing stage further comprises a counter configured to deliver a current value i, wherein the current value i corresponds to half of a rank of a current iteration of an even rank of the CORDIC algorithm, and wherein the first electronic circuit comprises:
a first circuit input, a second circuit input, a third circuit input;
a first divider module comprising an input connected to the second circuit input and a first subtractor configured to subtract a value 2i from an exponent of a data item present at the second circuit input, an output of the first subtractor delivering the data item present at the second circuit input divided by 2²ⁱ;
a second divider module comprising an input connected to the first circuit input and a second subtractor configured to subtract the value 2i from an exponent of a data item present at the first circuit input, an output of the second subtractor delivering the data item present at the first circuit input divided by 2²ⁱ;
a first adder/subtractor comprising a first input connected to the first circuit input and a second input connected to the output of the first subtractor;
a second adder/subtractor comprising a first input connected to the second circuit input and a second input connected to the output of the second subtractor; and
a third adder/subtractor comprising a first input connected to the third circuit input and a second input to receive an angular pitch value associated with the value 2i,
wherein a configuration of each of the first, second, and third adder/subtractor as an adder or as a subtractor is defined by a sign of the data item present at the second circuit input.

11. The digital signal processor according to claim 10, wherein:
the first input of the first adder/subtractor of the second circuit is connected to an output of the first adder/subtractor of the first circuit;
the first input of the second adder/subtractor of the second circuit is connected to an output of the second adder/subtractor of the first circuit;
the first input of the third adder/subtractor of the second circuit is connected to an output of the third adder/subtractor of the first circuit;
the input of the first divider module of the second circuit is connected to the output of the second adder/subtractor of the first circuit, and the first subtractor of the first divider module of the second circuit is configured to subtract a value 2i+1 from an exponent of a data item present at the output of the second adder/subtractor of the first circuit of circuit, the output of the first divider module of the second circuit delivering the data item present at the output of the second adder/subtractor of the first circuit divided by 2²ⁱ⁺¹;
the input of the second divider module of the second circuit is connected to the output of the first adder/subtractor of the first circuit, and the second subtractor of the second divider module of the second circuit is configured to subtract the value 2i+1 an the exponent of a data item present at the output of the first adder/subtractor of the first circuit of circuit, the output of the second divider module of the second circuit delivering the data item present at the output of the first adder/subtractor of the first circuit of circuit divided by 2²ⁱ⁺¹;
the second input of the third adder/subtractor of the second circuit is configured to receive an angular pitch value associated with the value 2i+1; and
wherein a configuration of each of the first, second, and third adder/subtractor of the second circuit as an adder or as a subtractor is defined by a sign of the data item present at the output of the second adder/subtractor of the first circuit.

12. The digital signal processor according to claim 11, wherein the processing stage further comprises a controller configured to:
at the beginning of a first iteration of the CORDIC algorithm, deliver an initial abscissa data item representative of the abscissa of the vector on the first circuit input, an initial ordinate data item representative of the ordinate of the vector on the second circuit input, and an initial angular value on the third circuit input;
increment the counter at each subsequent new iteration of the CORDIC algorithm;
deliver on the second input of the third adder/subtractor of the first circuit, an angular pitch value associated with the value 2i;
deliver on the second input of the third adder/subtractor of the second circuit, an angular pitch value associated with the value 2i+1; and
deliver, at the end of the iteration of an odd rank following an iteration of an even rank of the CORDIC algorithm, an output value of the first adder/subtractor of the second circuit on the first circuit input, an output value of the second adder/subtractor of the second circuit on the second circuit input, and an output value of the third adder/subtractor of the second circuit on the third circuit input.

13. The digital signal processor according to claim 12, wherein the processing stage further comprises an initialization electronic circuit, controlled by the controller, and configured to deliver the initial abscissa data item, the initial ordinate data item, and the initial angular value from the abscissa and the ordinate of the vector.

14. The digital signal processor according to claim 13, wherein the initialization circuit is configured to deliver, as the initial abscissa data item, the initial ordinate data item, and the initial angular value, respectively:
the abscissa of the vector, the ordinate of the vector, and a zero angular value, in response to the abscissa of the vector being positive;
the opposite of the ordinate of the vector, the abscissa of the vector, and an angular value equal to −π/2, in response to the abscissa and the ordinate of the vector being negative; and
the ordinate of the vector, the opposite of the abscissa of the vector and an angular value equal to +π/2, in response to the abscissa of the vector being negative and the ordinate of the vector being positive.

15. A servo system comprising:
a servo loop integrating the digital signal processor according to claim 1; and
an electric motor connected to the servo-control loop.

16. A digital signal processor comprising:
an initialization circuit configured to receive Cartesian coordinates of a vector in a floating point format, and to deliver an initial value of polar coordinates of the vector in a floating point format;
a first electronic circuit configured to receive the initial value of the polar coordinates of the vector, to implement a first iteration of a first even rank of a CORDIC algorithm in a floating point format, and to output a first approximation of the polar coordinates of the vector in a floating point format; and
a second electronic circuit configured to receive the first approximation of the polar coordinates of the vector, to implement an iteration of an odd rank of the CORDIC algorithm in a floating point format, and to output a second approximation of the polar coordinates of the vector in a floating point format.

17. The digital signal processor of claim 16, wherein the first electronic circuit has a similar structure as the second electronic circuit.

18. The digital signal processor of claim 16, wherein the first electronic circuit is further configured to receive the second approximation of the polar coordinates of the vector, to implement a second iteration of a second even rank of the CORDIC algorithm in a floating point format, and to output a third approximation of the polar coordinates of the vector in a floating point format.

19. A method comprising:
receiving Cartesian coordinates of a vector in a floating point format; and
iteratively implementing a CORDIC algorithm in the floating point format to generate polar coordinates of the vector in the floating point format, the iterative implementation being performed synchronously with a clock signal; and
outputting the polar coordinates of the vector in the floating point format.

20. The method according to claim 19, further comprising using the polar coordinates of the vector in the floating point format to implement a servo-control of an electric motor.

21. The method according to claim 19, wherein implementing the CORDIC algorithm comprises performing divisions by integer powers of 2 of data expressed in a floating point format by subtracting for each division, the integer power corresponding to an exponent of the data.

22. The method according to claim 19, wherein implementing the CORDIC algorithm comprises implementing two iterations of the CORDIC algorithm per clock signal cycle.
